(19) United States
(12) Patent Application Publication
(10) Pub. No.: US 2011/0007505 A1
(43) Pub. Date: Jan. 13, 2011

(54) LIGHT SOURCE MODULE AND LED STREET LAMP USING THE SAME

(76) Inventor: Pei-Choa WANG, Gueishan Township (TW)

Correspondence Address: HDLS Patent & Trademark Services, P.O. BOX 220746, CHANTILLY, VA, 20153-0746, US

(21) Appl. No.: 12/501,559

(22) Filed: Jul. 13, 2009

(51) Int. Cl. F21V 1/00

(52) U.S. Cl. 362/235

(57) ABSTRACT

A light source module includes a base, at least one light emitting diode device, a reflector and a transparent plate. The light emitting diode device is arranged on the base. The reflector is arranged on the base and around the light emitting diode device. The transparent plate is arranged on the reflector and forms a plurality of Fresnel lens portions facing the light emitting diode device. The Fresnel lens portions are aligned along a predetermined direction. The invention further provides a street lamp having the abovementioned light source module.

### BACKGROUND OF THE INVENTION

1. Field of the Invention

The present invention relates to an illumination device, and more particular to a light emitting diode (LED) street lamp and its light source module.

2. Description of Prior Art

Light emitting diode (LED) has a high illuminating efficiency, such that LED is applied to various illumination devices extensively to save power of an energy source. Besides indoor lamps such as table lamps, street lamps for illuminating streets and roads at nighttime gradually adopt LED as a light source to save the energy for huge power consumption.

Most traditional LED street lamps combine a plurality of LED devices or modules to provide sufficient illumination for roads and streets. With reference to FIG. 1, each street lamp 10 is installed along an extending direction of a road 11 and with a predetermined interval length L apart, and an illumination range 12 provided by connecting each street lamp 10 can give a complete illumination for the road 11.

However, the illumination range 12 of each street lamp 10 extended along the road 11 has a predetermined width R which affect an interval length L of each street lamp 10 directly. The longer the predetermined width R of the illumination range 12, the longer is the predetermined interval length L from its adjacent street lamp 10, and the smaller is the number of street lamps required for the road of a predetermined length.

Therefore, it is an important subject for street lamp manufacturers to improve the street lamp 10, such that the predetermined width R of the illumination range 12 along the extending direction of the road 11 can be increased to reduce the number of street lamps required for a road of a predetermined length.

### SUMMARY OF THE INVENTION

It is a primary objective of the present invention to provide a light source module capable of serving as a light source of a street lamp and increasing the predetermined width of the illumination range of the street lamp along the extending direction of the road to reduce the number of street lamps required by the road.

Another objective of the present invention is to provide an LED street lamp whose illumination range along the extending direction of the road has a longer predetermined width to reduce number of street lamps required by the road.

To achieve the foregoing objectives, the present invention provides a light source module comprising a base, at least one LED device, a reflector, and a transparent plate. The LED device is installed on the base. The reflector is connected to the base and disposed around the LED device. The transparent plate is installed on the reflector, and the transparent plate forms a plurality of Fresnel lens portions facing the LED device, and the Fresnel lens portions are arranged along a predetermined direction.

The present invention further provides an LED street lamp installed on a road, and the road has a predetermined extending direction. The LED street lamp comprises a lamppost installed on the road, a lamp seat installed at a top end of the lamppost, and at least one light source module installed on the lamp seat for projecting light onto the road. The light source module includes a base connected to the lamp seat, at least one LED device installed on the base, a reflector connected to the base and disposed around the LED device, and a transparent plate installed on the reflector, and the transparent plate forms a plurality of Fresnel lens portions facing the LED device, and the Fresnel lens portions are arranged along a predetermined extending direction of the road.

### BRIEF DESCRIPTION OF DRAWINGS

FIG. 1 is a schematic view of a traditional street lamp;

FIG. 2 is a schematic view of an LED street lamp in accordance with a preferred embodiment of the present invention;

FIG. 3 is a cross-sectional view of an LED street lamp in accordance with a preferred embodiment of the present invention;

FIG. 4 is a schematic view of a light source module of an LED street lamp in accordance with the present invention;

FIG. 5 is a schematic view of the light source module;

FIG. 6 is a schematic view of a transparent plate of the light source module;

FIG. 7 is a schematic view showing the operation of the light source module;

FIG. 8 is schematic view showing the operation of the LED street lamp;

FIG. 9 is a schematic view of the transparent plate according to another preferred embodiment;

FIG. 10 is a schematic view of the transparent plate according to still another preferred embodiment;

FIG. 11 is a schematic view of the transparent plate according to still another preferred embodiment;

FIG. 12 is a schematic view of the transparent plate according to still another preferred embodiment; and

FIG. 13 is a schematic view of the transparent plate according to still another preferred embodiment.

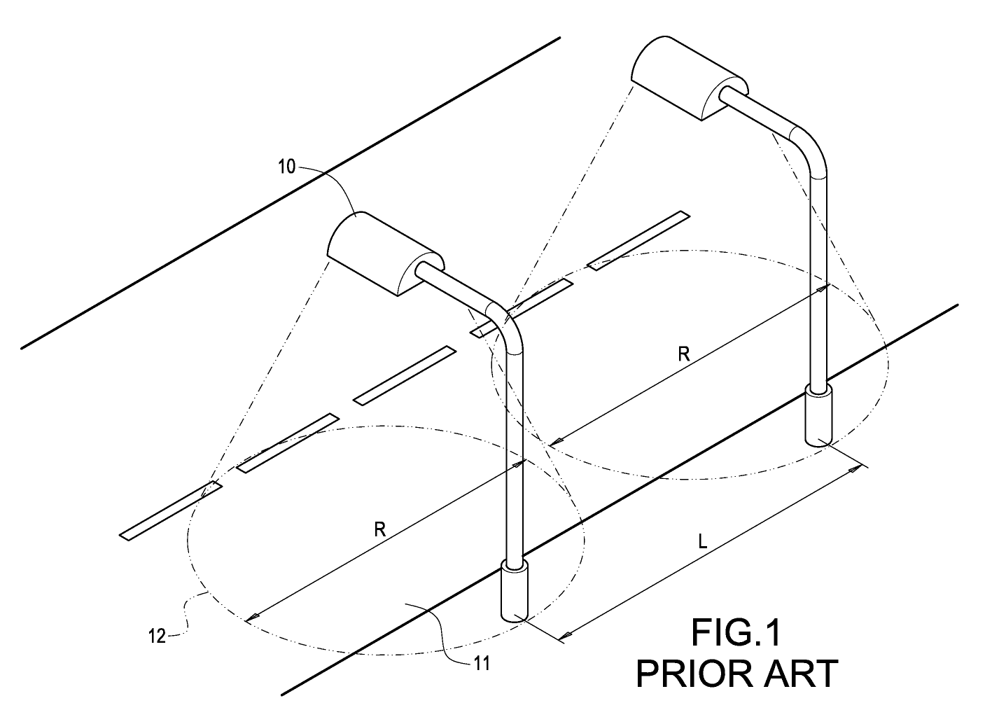

### DETAILED DESCRIPTION OF THE INVENTION

The technical characteristics, features and advantages of the present invention will become apparent in the following detailed description of the preferred embodiments with reference to the accompanying drawings.

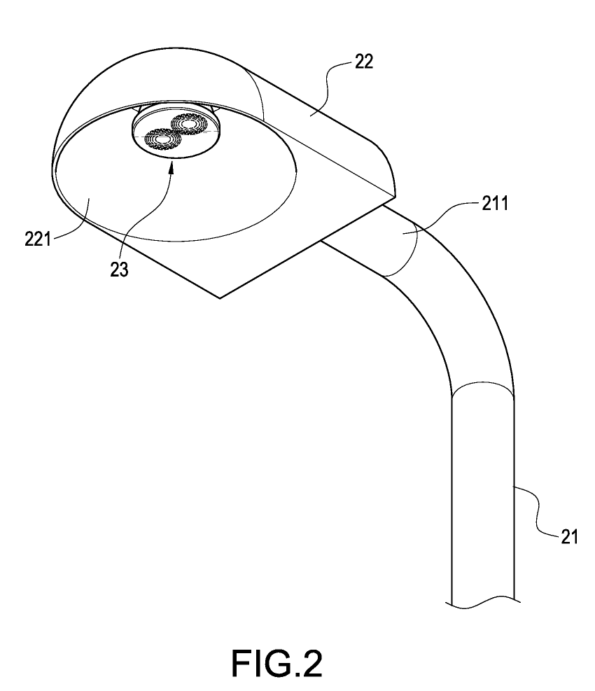

With reference to FIG. 2 for an LED street lamp in accordance with a preferred embodiment of the present invention, the LED street lamp 20 comprises a lamppost 21, a lamp seat 22, and a light source module 23. The lamppost 21 is installed on a road, and the lamp seat 22 is installed at a top end 211 of the lamppost 21. The lamp seat 22 forms a cavity 221 disposed concavely upward at the bottom side of the lamp seat 22.

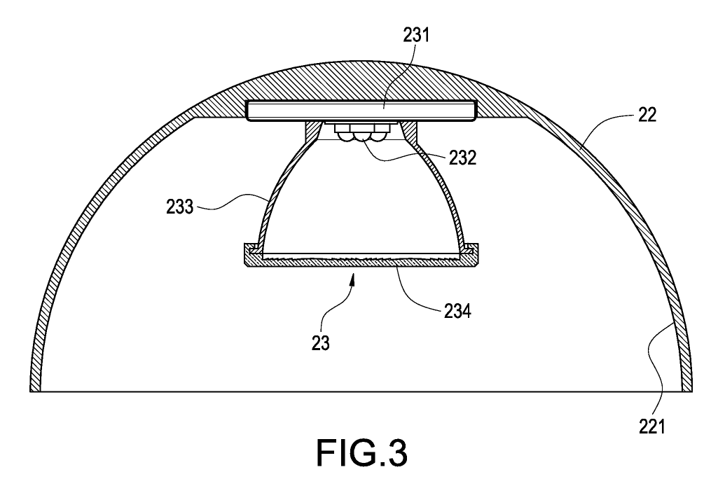

With reference to FIG. 3, the light source module 23 is installed inside the cavity 221 of the lamp seat 22 for projecting light downward. Each light source module 23 includes a base 231 connected onto the lamp seat 22, at least one LED device 232 installed on the base 231, a reflector 233 connected to the base 231 and disposed around the LED device 232, and a transparent plate 234 installed on the reflector 233. Preferably, the base 231 is a flat heat pipe for dissipating heat for the LED devices 232.

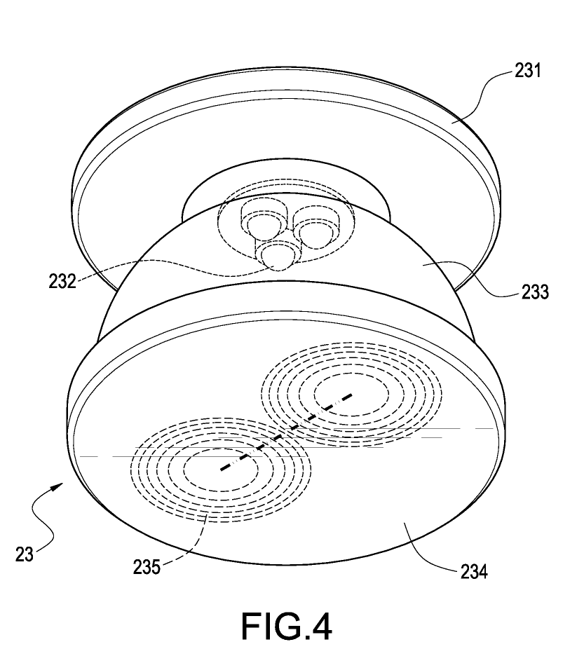

With reference to FIGS. 4 and 5, the transparent plate 234 includes two Fresnel lens portions 235 disposed opposite to one another and protruded towards the LED device 232. The Fresnel lens portions 235 are arranged along a predetermined direction. The predetermined direction is the central connecting direction of the Fresnel lens portions 235.

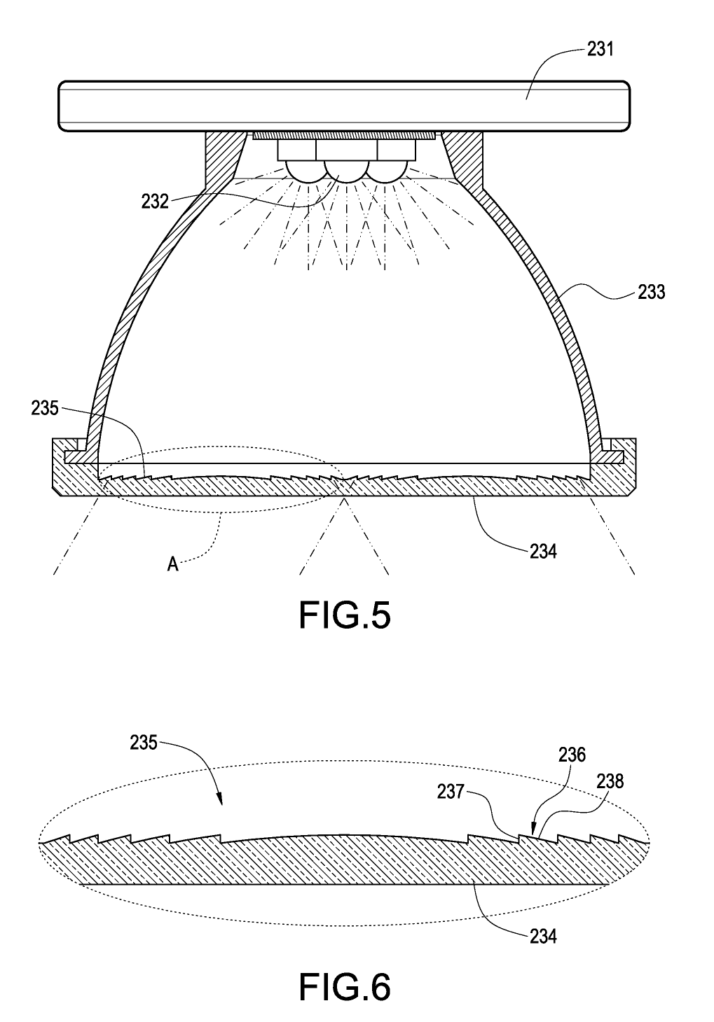

With reference to FIG. 6, each Fresnel lens portion 235 is formed by a plurality of concentric protruding rings 236 protruded upwardly from the transparent plate 234, and each protruding ring 236 has an internal side 237 and an external side 238 connected with each other. The internal side 237 is substantially perpendicular to the vertical side of the transparent plate 234, and the external side 238 is an oblique surface or an externally convex surface. Each Fresnel lens portion 235 can refract light similar to a traditional convex lens, but the Fresnel lens portion 235 has the advantage of greatly reducing volume and weight over the traditional convex lens.

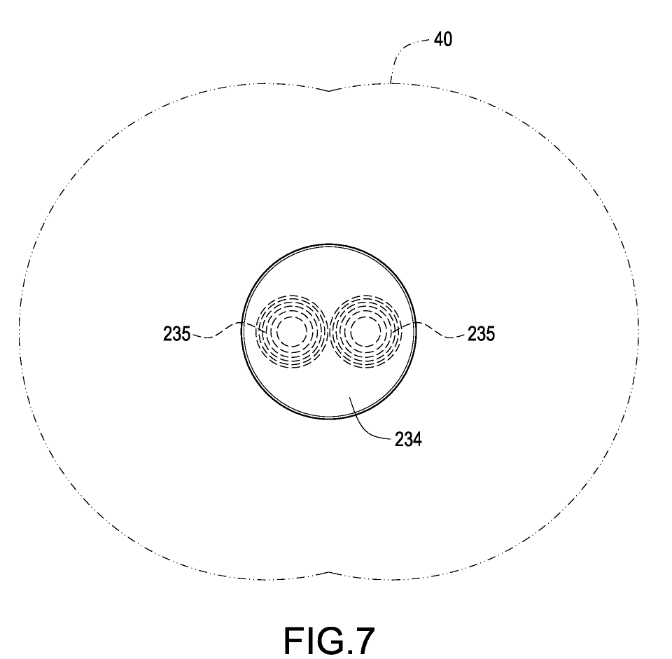

With reference to FIG. 7, lights refracted from the Fresnel lens portions 235 can be projected from the transparent plate 234 onto a predetermined surface and are concentrated within a long elliptical area 40 as shown in FIG. 7. In other words, the distribution of lights from the transparent plate 234 is not in a symmetrical circular shape, but in an asymmetric elliptical shape.

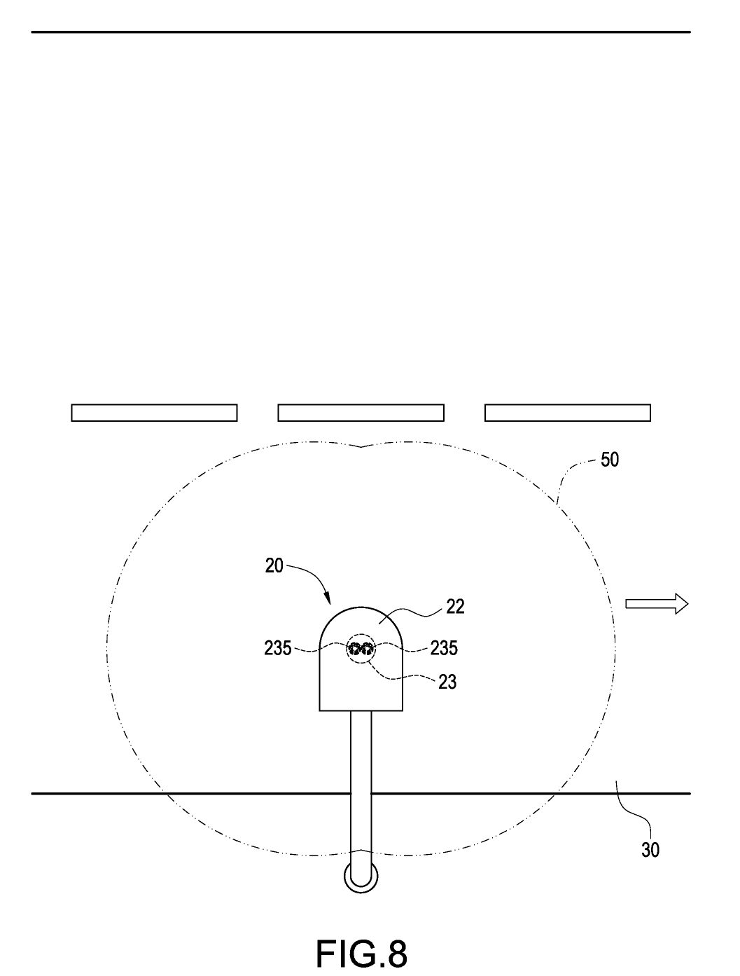

If the LED street lamp of the present invention is applied to a road as shown in FIG. 8, the street lamp 20 is installed on a road 30, and the Fresnel lens portions 235 are in the same direction as a predetermined extending direction (as indicated by an arrowed direction in the figure) of the road 30, such that the present invention can use the asymmetric light distribution of the transparent plate 234 to provide a greater width of the illumination range 50 of the LED street lamp in the extending direction (as indicated by an arrowed direction in the figure) of the road 30, so as to reduce the number of street lamps required by the road of a predetermined length.

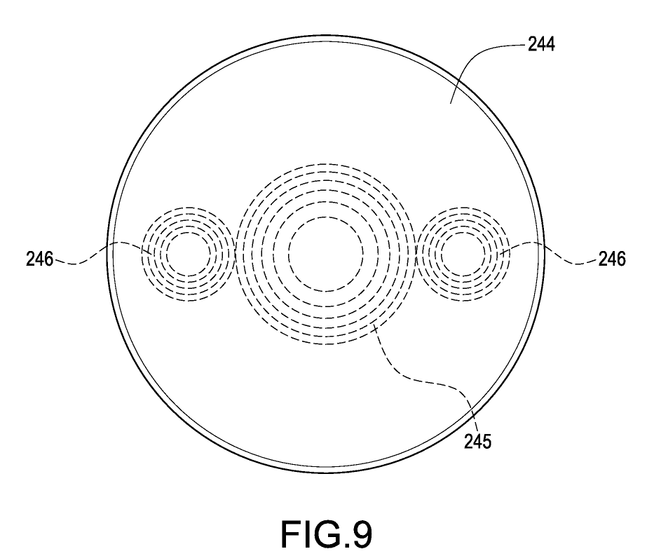

With reference to FIG. 9 for the transparent plate according to another preferred embodiment, the transparent plate 244 forms three Fresnel lens portions 245 along a predetermined direction, and the Fresnel lens portion 245 at the middle has a diameter greater than the diameter of the remaining Fresnel lens portions 246, such that the distribution of lights projected outwardly from the transparent plate 244 can be adjusted.

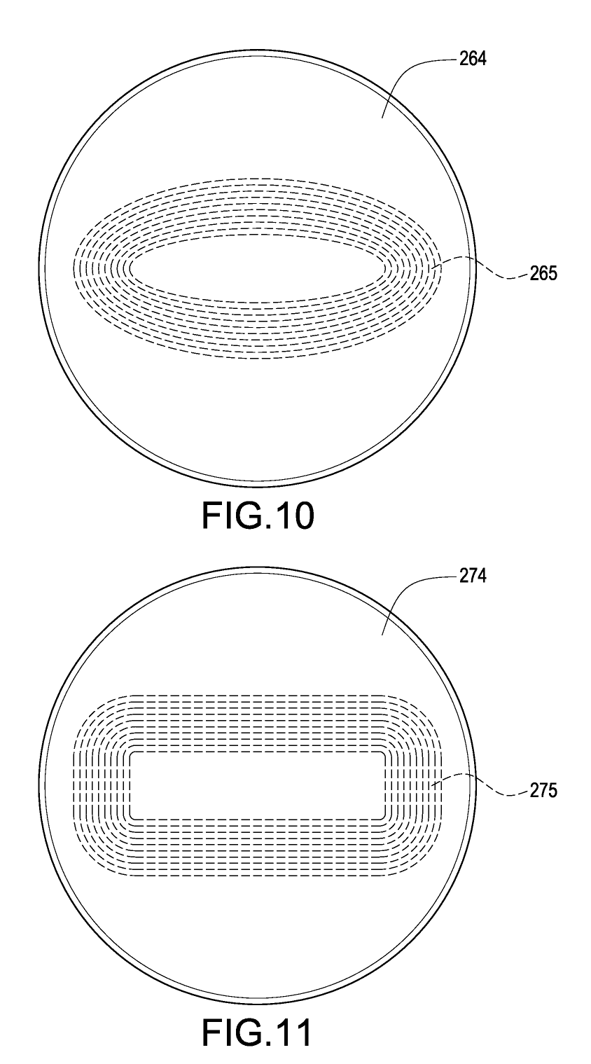

With reference to FIG. 10 for the transparent plate according to a further preferred embodiment, the transparent plate 264 forms elliptical Fresnel lens portions 265 for adjusting the distribution of lights projected outwardly from the transparent plate 264 into a substantially asymmetric elliptical distribution.

With reference to FIG. 11 for another preferred embodiment of the transparent plate, the transparent plate 274 forms a rectangular Fresnel lens portion 275 for adjusting the distribution of lights projected outwardly from the transparent plate 274 into a substantially asymmetric rectangular distribution.

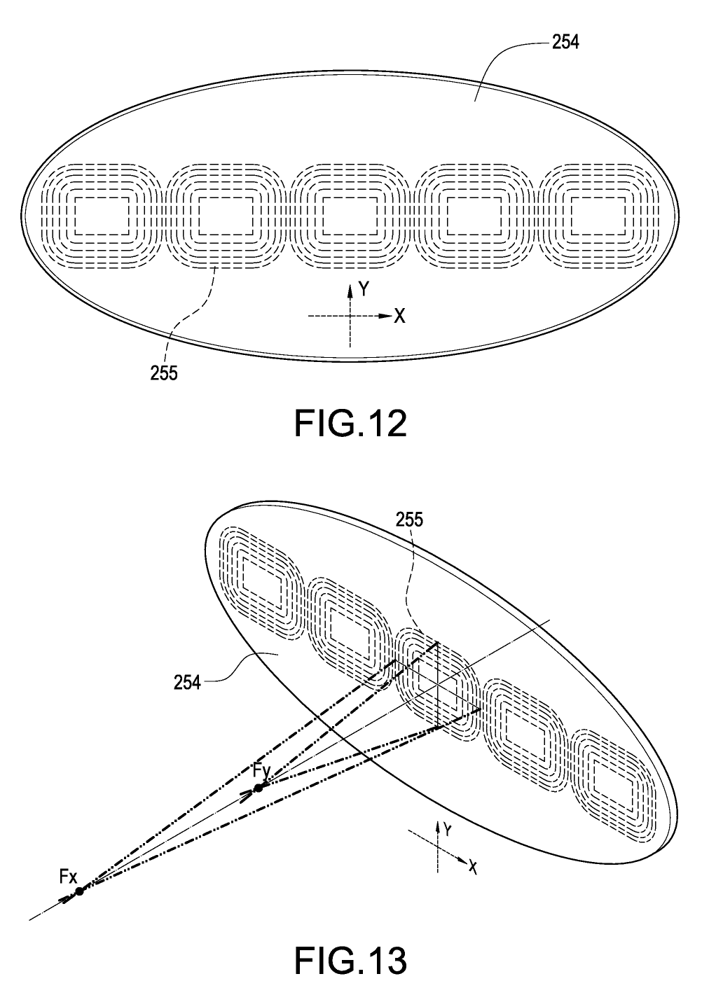

With reference to FIG. 12 for another preferred embodiment of the transparent plate, the transparent plate 254 is in an elliptical shape and forms five Fresnel lens portions 255 of an equal diameter. Each Fresnel lens portions 255 is arranged in a predetermined X-direction, and each Fresnel lens portion 255 has a different focal length, and the asymmetry of the light distribution can be adjusted according to the actual requirements of the road. It is noteworthy to point out that each Fresnel lens portion on the same transparent plate has a different focal length or can be one of the Fresnel lens portions illustrated in FIGS. 2 to 11.

To improve the asymmetry of the light distribution of the lights projected from the Fresnel lens portions 255, the present invention further uses an optical simulation program to create Fresnel lens portions 255 of the transparent plate 254 with the design of an asymmetric focal length by an injection molding method. With reference to FIG. 13, Y-direction is perpendicular to X-direction, and the Fresnel lens portions 255 in the X-direction have a focal length Fx greater than the focal length Fy in the Y-direction, such that after lights are passed through the Fresnel lens portions 255, the degree of divergence in the X-direction is greater than the degree of divergence in the Y-direction to improve the asymmetry of light distribution. It is noteworthy to point out that the aforementioned design with an asymmetric focal length is applicable for the Fresnel lens portions as shown in FIGS. 2 to 11.

While the invention has been described by means of specific embodiments, numerous modifications and variations could be made thereto by those skilled in the art without departing from the scope and spirit of the invention set forth in the claims.

What is claimed is:

1. A light source module, comprising:
a base;
at least one LED device, installed on the base;
a reflector, coupled onto the base and disposed around the LED device; and
a transparent plate, installed on the reflector, and including a plurality of Fresnel lens portions facing the LED device, and the Fresnel lens portions being arranged along a predetermined direction.

2. The light source module of claim 1, wherein the transparent plate includes two Fresnel lens portions of an equal diameter.

3. The light source module of claim 1, wherein the transparent plate includes three Fresnel lens portions, and the Fresnel lens portion at the middle has a diameter greater than the diameter of the remaining Fresnel lens portions.

4. The light source module of claim 1, wherein the transparent plate includes five Fresnel lens portions of an equal diameter.

5. The light source module of claim 1, wherein each Fresnel lens portion has a focal length in a predetermined direction greater than a focal length in another direction perpendicular to the predetermined direction.

6. The light source module of claim 1, wherein the Fresnel lens portions have different focal lengths.

7. A light emitting diode (LED) street lamp, installed on a road, and the road having a predetermined extending direction, and the LED street lamp comprising:
a lamppost, installed on the road;
a lamp seat, installed at a top end of the lamppost;
at least one light source module, installed on the lamp seat for projecting a light towards the road, and the light source module including a base connected to the lamp seat, at least one LED device installed on the base, a reflector connected to the base and disposed around the LED device, and a transparent plate installed onto the reflector, and the transparent plate including a plurality of Fresnel lens portions facing the LED device, and the Fresnel lens portions being substantially arranged in a predetermined extending direction of the road.

8. The light source module of claim 7, wherein the transparent plate includes two Fresnel lens portions of an equal diameter.

9. The LED street lamp of claim 7, wherein the transparent plate includes three Fresnel lens portions, and the Fresnel lens portion at the middle has a diameter greater than the diameter of the remaining Fresnel lens portions.

10. The LED street lamp of claim 7, wherein the transparent plate includes five Fresnel lens portions of an equal diameter.

11. The LED street lamp of claim 7 or 10, wherein each Fresnel lens portion has a focal length in a predetermined direction greater than a focal length in another direction perpendicular to the predetermined direction.

12. The LED street lamp of claim 7, wherein the Fresnel lens portions have different focal lengths.
